(19) United States
(12) Patent Application Publication
(10) Pub. No.: US 2007/0101653 A1
(43) Pub. Date: May 10, 2007

(54) Hinge assembly for casement windows

(76) Inventors: Dan Bruzek, Ellendale, MN (US); John E. Titus, Lonsdale, MN (US); Tim Frenzen, Owatonna, MN (US); Clark Velzke, Medford, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/268,759

(22) Filed: Nov. 7, 2005

(51) Int. Cl. E05D 15/28

(52) U.S. Cl. 49/246

(57) ABSTRACT

A hinge assembly for a casement window including a track having a cam engaging portion defining a tri-lobular aperture, a sash arm pivotably and slidably coupled to the track, and a support arm pivotably coupled to the track on a first end and to the sash arm at the opposing end. An adjustable cam is operably connected through the support arm to engage the non-circular aperture within the track such that rotation of the adjustable cam selectively shifts the position of the support arm relative to the track to alleviate sash sag.

### FIELD OF THE INVENTION

The invention relates to an improved casement window, and in particular to a casement window hinge assembly having structure to reduce sash sag.

### BACKGROUND OF THE INVENTION

Casement windows assemblies are well known in the art and described in, for example, U.S. Pat. No. 3,845,585 to Cecil, entitled “Casement Window,” and U.S. Pat. No. 4,254,583 to Smits et al., entitled “Window Unit,” which are both hereby incorporated by reference herein. In general, a casement window includes a window sash comprised of a sheet of glass surrounded by wood, vinyl or metal structure. A casement window has the sash hinged to one side in comparison to windows where the sash slides within the frame. The window sash engages the window frame though an upper and lower hinge assembly. The casement window sash swings on a hinge within the window frame along a vertical axis. Typically a crank mechanism is attached to the lower hinge for selectively opening and closing the window sash. Proper performance of the casement window requires that the window sash be properly aligned within the window frame.

One of the more common issues regarding casement windows is sash sag, which occurs when the sash portion of the window is out of square with the window frame. Sash sag can result from movement during installation, improper hinge positioning by the window manufacturer, settling of the building, warpage of the window or from external contact with the window sash in the open position. A window with sash sag will not properly seal. As a result the window is less effective in preventing moisture from coming in to the structure as well as increasing energy costs for heating and cooling of the building. Moreover, the improper seal may allow moisture into the window frame itself, which can lead to rotting of the window frame and the structure.

Correction of sash sag requires realigning the hinge so that the sash sits properly within the window frame. On some windows this requires disassembly of the hinge, which is labor intensive and costly. In the alternative, sash sag may be corrected with an adjustable hinge mechanism. An example of an adjustable mechanism designed to alleviate sash sag is disclosed in U.S. Patent Re. 34,657 ('657 reissue) to La See, entitled “Cam Adjustment Device For Casement Window Unit,” which is hereby incorporated by reference herein. More specifically, the '657 reissue discloses an index cam comprising a series of serrations that can engage a plurality of serrations on the track of the hinge assembly, which permits the cam to move relative to the track and facilitates adjustment of a link connected to a casement window sash. However, the engagement of the serrations on the cam with corresponding serrations on the track only permits predetermined, or defined, movements of the cam within the track. Additionally, the detailed structure of the cam and the track can increase manufacturing costs and make it make difficult to adjust the window sash once the hinge assembly has been installed.

With the number of residential casement windows being installed in new and existing homes, it would be desirable to provide a hinge assembly that can reduce or eliminate sash sag and overcome the limitations mentioned above. What is still needed is an adjustable hinge assembly that can be easily adjusted without disassembly of the casement window to reduce and/or eliminate sash sag, and that can be manufactured at a lower cost relative to existing hinge assemblies.

### SUMMARY OF THE INVENTION

The hinge assembly of the present invention addresses the above-mentioned needs by providing a mechanism that can be adjusted to compensate for sash sag without requiring disassembly of the casement window assembly. Additionally, the hinge assemblies of the present disclosure do not comprise locking structures and therefore can be manufactured at lower costs relative to existing hinges.

In a first embodiment, the improved hinge assembly includes a track having an upwardly struck cam engaging portion defining a tri-lobular aperture, a first elongated arm or sash arm pivotably coupled to a slide on the track assembly, and a second elongated arm or support arm pivotably coupled to the track assembly and to the first elongated arm. The improved hinge further includes a cam member operably coupling the second elongated arm and the track. The cam member has a bi-lobular cam portion adapted to engage the cam engaging structure of the track such that the cam portion is selectively shiftable within the cam engaging structure. Shifting the cam portion within the cam engaging structure facilitates positional adjustment of the second elongated arm, and the attached window sash, which can reduce and/or eliminate sash sag. The cam engaging structure can be a tri-lobed aperture, while the cam portion can comprise an oval shape, an elliptical shape or the like. In embodiments where the aperture engaging portion is a bi-lobular, generally oval shaped cam, the cam portion can allow the cam member to be shifted up to about thirty-five degrees longitudinally in either direction from a center position within the tri-lobular aperture.

Due to the structure of the cam engaging structure and the cam portion, the second elongated arm and the attached window sash can be adjusted relative to the track such that sash sag can be reduced and/or eliminated. In some embodiments, the cam portion is biased against the track with a retainer, thereby creating friction for resisting movement of the cam portion within the cam engaging structure. This friction enables the adjustable cam to maintain position without the use of locking structures such as protrusions, serrations or the like, which in turn enables finer adjustment of the second elongated arm. Moreover, since the cam portion and the cam engaging structure do not comprise locking structures such as protrusions or serrations, the hinges of the present disclosure can be manufactured at a lower cost than hinges having locking structures and the like. The structure of the cam portion, along with the cam engaging structure, can also facilitate adjustment of the second elongated arm, and the attached window sash, without disassembling the sash from the hinge assembly.

In a first aspect, the invention pertains to a hinge for use with casement window assemblies having a track with a cam engaging portion defining a tri-lobed aperture, a first elongated arm pivotably coupled to a slide on the track, and a second elongated arm pivotably coupled to the track and to the first elongated arm. In these embodiments, the cam member is operably coupled to the second elongated arm and has an oval bi-lobular engaging portion positioned within the tri-lobed aperture, wherein the oval engaging portion is selectively shiftable in the tri-lobed aperture.

In a second aspect, the invention pertains to a cam for use in a hinge assembly, the cam including a body portion having a first end and a second end, an oval engaging portion oriented towards the first end, and a link engaging stud portion oriented towards the second end. In these embodiments, the oval engaging portion can be adapted to engage with and move within a corresponding aperture in a track such that the cam member can be selectively shifted up to about thirty-five degrees longitudinally in either direction from a center position within the aperture.

In a third aspect, the invention pertains to a method of reducing sash sag, the method including adjusting an elongated arm connected to a cam member having an oval engaging portion, wherein the oval engaging portion is positioned within a tri-lobed aperture of a track.

### BRIEF DESCRIPTION OF THE FIGURES

FIG. 1 is a perspective view of a casement window assembly;

FIG. 2 is a plan view of a hinge assembly of the present disclosure, wherein the hinge is depicted in the open position;

FIG. 3 is a top plan view of the track of the hinge assembly of the present disclosure;

FIG. 4 is a side plan view of the track of FIG. 3;

FIG. 5 is a cross-sectional view of the hinge assembly of FIG. 2 depicting the tri-lobed aperture and a cam member positioned within the tri-lobed aperture;

FIG. 6 is a perspective view of a cam member depicting an oval engaging portion that can engage a tri-lobed aperture;

FIG. 7 is a plan view of a cam member having an oval engaging portion positioned within a tri-lobed aperture, wherein the oval engaging portion is centered within the tri-lobed aperture;

FIG. 8 is a plan view of a cam member having an oval engaging portion positioned within a tri-lobular aperture, wherein the oval engaging portion is shifted to the maximum travel limit in one direction;

FIG. 9a is a side view of an embodiment of a cam member having a bullet shaped engagement portion;

FIG. 9b is a top view of the cam member of FIG. 9a;

FIG. 9c is a bottom view of the cam member of FIG. 9a;

FIG. 10a is a plan view of an alternate embodiment of a hinge assembly according to the invention;

FIG. 10b is an enlarged view of a portion of the plan view of FIG. 10a depicting the generally tri-lobular aperture;

FIG. 10c is a perspective view of the cam member of FIG. 9a;

FIG. 10d is a plan view of the cam member of FIG. 9a engaged in the track aperture, wherein the cam member is centered within the aperture;

FIG. 10e is a plan view of the cam member of FIG. 9a engaged in the track aperture, wherein the cam member is shifted to the limit of travel in one direction within the aperture; and

FIG. 10f is a cross sectional view of the cam member and track taken along section 10f-10f of FIG. 10e.

### DETAILED DESCRIPTION OF THE INVENTION

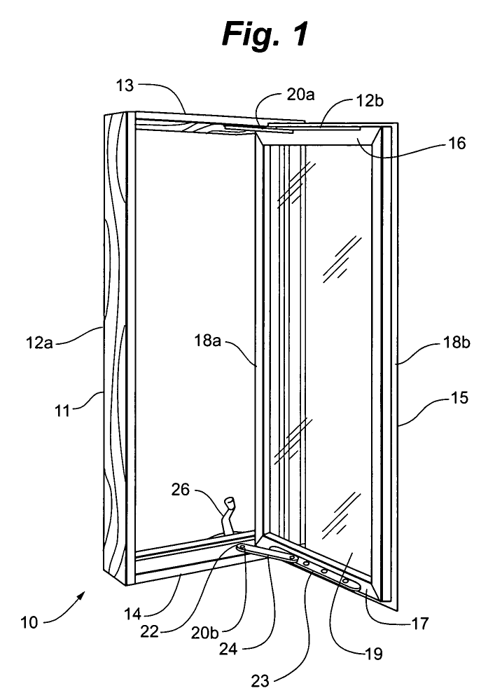

The present invention is an adjustable cam unit disposed within a casement window hinge for alleviating sash sag. As depicted in FIG. 1, a conventional residential casement window assembly 10 generally includes a window frame 11 with a window sash 15 hinged therein on upper and lower hinge assemblies 20a, 20b. Window frame 11 has two vertical frame members 12a, 12b, an upper horizontal frame 13, and a lower horizontal frame 14. Window sash 15 generally includes an upper horizontal member 16, a lower horizontal member 17, vertical frame members 18a, 18b and a glass panel 19. In general, window sash 15 is sized to closely fit within window frame 11 in order to seal out moisture and maintain the environment within the structure.

Upper and lower hinge assemblies 20a, 20b, which facilitate hingably mounting the window sash 15 to the window frame 11. The hinge assemblies 20a, 20b generally include a track 22 mounted to the window frame 11, a sash arm 23 coupled to the window sash 15 with one end longitudinally slidable on track 22, and a support arm 24 pivotally coupled on a first end to track 22 and to sash arm 23 at the opposing end. In operation, window sash 15 pivots in and out of frame 11 on hinge assemblies 20a, 20b by rotating crank mechanism 26. While the present description generally refers to casement windows, the present invention could be used with other types of window hinges including awning style windows.

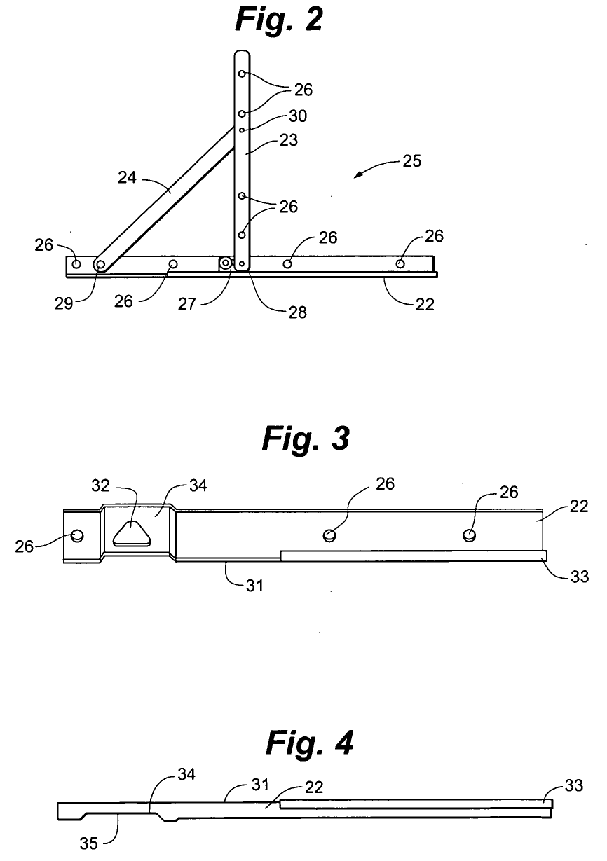

Referring to FIG. 2, an embodiment of hinge assembly 25 according to the invention is depicted. Hinge assembly 25 generally includes track 22, sash arm 23, support arm 24 mounted at a first end to track 22 by adjustable cam 29 and at an opposing end to sash arm 23. Track 22 includes multiple anchoring holes 26 for mounting to window frame 11 with screws, nails or other suitable fasteners. Sash arm 23 includes multiple anchoring holes 26 for mounting to window sash 15 with screws, nails or other suitable fasteners.

Track 22 is operably connected to sash arm 23 through a slide block 27. Slide block 27 includes a pivotable connection 28 to sash arm 23 that allows for rotation of the sash arm 23 about the vertical axis. Slide block 27 is longitudinally slidable on track 22 so that the sash arm connection 28 may move longitudinally along track 22. Track 22 is also operably connected to support arm 24 through adjustable cam 29 that enables rotation about the vertical axis as well as selective longitudinal movement. Opposing end of support arm 24 is mounted to a pivotable intermediate link 30 of sash arm 24 that allows for rotation about a vertical axis.

As depicted in FIGS. 3-5, track 22 includes flange 31 extending the length of track 22. Flange 31 defines a lip portion 33 for guiding and locating slide block 27. The slide block 27 engages lip portion 33 of track 22 to permit longitudinal sliding movement along track 22 as sash arm 23 pivots during operation of hinge assembly 25. Track 22 has raised cam platform 34 defining pocket 35 between window frame 11 and track 22. In some embodiments, the side portions of raised cam platform 34 may be sloped from about 40 degrees to about 75 degrees relative to lower horizontal frame 14 of window frame 11. Pocket 35 allows for fastening of adjustable cam 29 to the underside or window frame side of track 22 as further described hereinbelow. A cam engaging structure 32a in the form of aperture 32 is defined in raised cam platform 34. It will be appreciated that in other embodiments, cam engaging structure 32a need not be an aperture extending through track 22, but may be a pocket or other similar structure for receiving a cam.

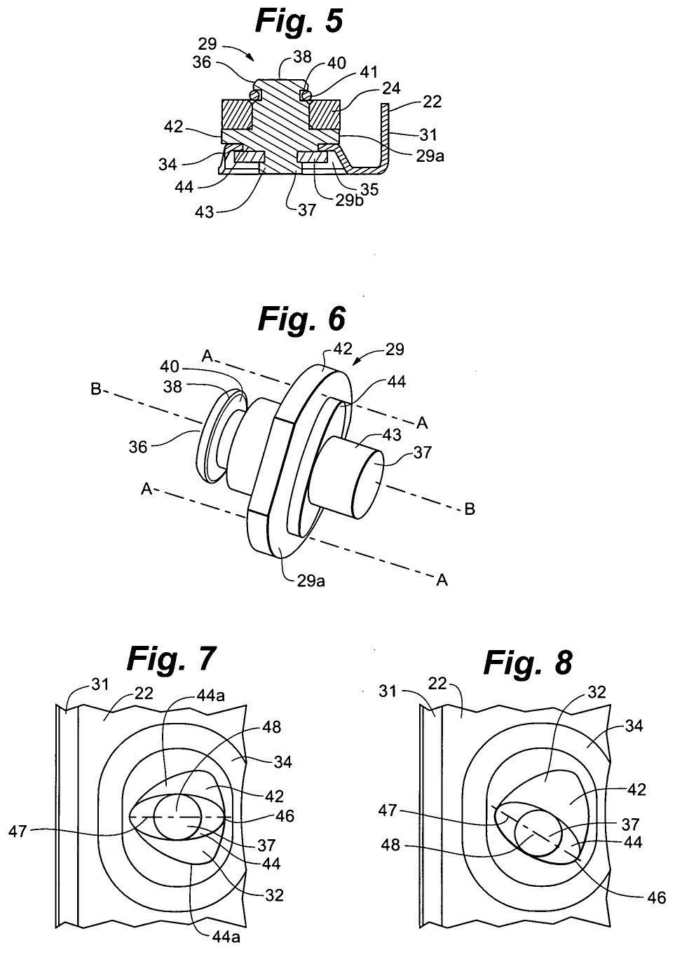

As depicted in FIGS. 5-6, adjustable cam 29 generally includes cam body 29a, retainer 29b, and keeper 41. Cam body 29a presents first end 36 and second end 37 and is substantially symmetrical with respect to axis B-B. Link engaging stud portion 38 is oriented towards first end 37 and aperture-engaging portion 39 is oriented towards second end 37. Link engaging stud portion 38 defines groove 40 for receiving keeper 41 to pivotably secure support arm 24 to adjustable cam 29. In some embodiments, keeper 41 may be an o-ring composed of metal, plastic, rubber or combinations thereof. As depicted in FIG. 6, keeper 41 is received in groove 40 to retain support arm 24 on link engaging stud portion 38. Additionally, cam body 29a includes guide plate portion 42 positioned between link engaging stud portion 38 and aperture engaging portion 37. Guide plate portion 42 is dimensioned so as to be larger than aperture 32, thereby preventing adjustable cam 29 from being drawn therethrough. Further, guide plate portion 42 may serve as a seat for guiding and supporting support arm 24.

Aperture engaging portion 39 generally includes post 43 and cam 44, both of which are substantially concentric with respect to axis B-B. In an embodiment of the invention, cam 44 may be generally oval shaped as depicted in FIGS. 6-8 so as to conform with the edges 44a of a tri-lobular aperture 32. Cam 44 and aperture 32 are coordinatingly dimensioned so that cam 44 is rotatably shiftable in aperture 32 about either or both vertical axes denoted A-A in the figures. It will be appreciated that, in other embodiments, cam 44 may have an elliptical shape or other shape enabling controlled rotational shifting within aperture 32. One of ordinary skill in the art will recognize that no particular shape for cam 44 is required by the present disclosure. Rather, the shape of cam 44 is guided by the shape of the particular corresponding aperture 32 employed in a particular hinge assembly.

Retainer 29b is received on post 43 so as to retain adjustable cam 29 within aperture 32 on track 22. In an embodiment, retainer 29b may be a metal ring interference fit onto post 43 so as to clamp track 22 between retainer 29b and guide plate portion 42. In other embodiments, retainer 29b may be an O-ring, split ring, or the like, made from metal, plastic, rubber or combinations thereof. Retainer 29b and post 43 are received in pocket 35 so that track 22 may be mounted flush to window frame 15.

The operation of adjustable cam 29 is depicted in FIGS. 7 and 8. In the depicted embodiment, aperture 32 is a tri-lobular non-circular opening adapted to engage corresponding structure on adjustable cam 29. As described above, cam 44 is generally oval shaped to conform with edges 44a of aperture 32. Cam 44, as depicted in FIGS. 7-8, contacts track 22 at the endpoints 46, 47 of the major axis 48. Cam 44 is rotatably shiftable within aperture 32 about either or both of endpoints 46, 47, which coincide with axes A-A. By rotating adjustable cam 29, axis B-B and post 37 which is concentric therewith, moves relative to the window frame 11 to shift the pivot point at which support arm 24 is pivotably connected with track 22, thereby slightly shifting the position of window sash 15 relative to window frame 11. Adjustable cam 29 is held in the adjusted position solely by the frictional forces between adjustable cam 29 and track 22 resulting from the clamping force applied to track 22 by retainer 29b and guide plate portion 42. Significantly, there are no discrete structures such as serrations, or protrusions on either adjustable cam 29 or aperture 32 for mechanically locking the device in a position.

Referring to FIG. 7, cam 44 is centered in tri-lobular aperture 32. From this position, cam 44 can be shifted in either direction about endpoint 47, which facilitates shifting adjustable cam 29 and the attached support arm 24 relative to track 22. Referring to FIG. 8, adjustable cam 29 and cam portion 44 are depicted as being shifted to the maximum travel limit within tri-lobular aperture 32. Preferably, cam 44 and aperture 32 are dimensioned so as to enable up to about 35 degrees of rotation in either direction about endpoint 47 when cam 44 is centered in tri-lobular aperture 32 as depicted in FIG. 7.

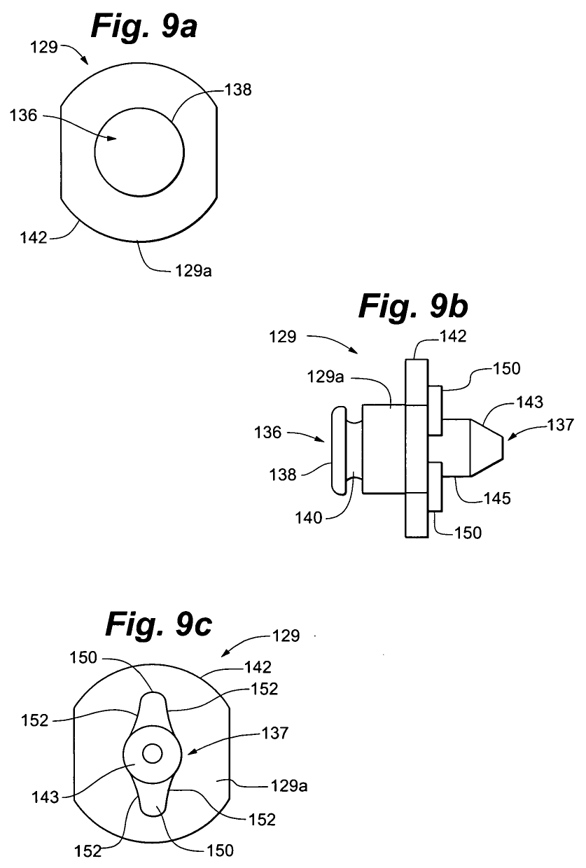

An alternative embodiment is depicted in FIGS. 9a-c and 10a-e for the adjustable cam. In the depicted embodiment, alternate aperture 132 has a “kernel-shaped” configuration. Adjustable cam 129 generally includes cam body 129a, retainer 129b, and keeper 141. Cam body 129a presents first end 136 and second end 137 and is substantially symmetrical with respect to axis B-B. Link engaging stud portion 138 is oriented towards first end 136 and aperture-engaging portion 139 is oriented towards second end 137. Link engaging stud portion 138 defines groove 140 for receiving keeper 141 to pivotably secure support arm 124 to adjustable cam 129. In some embodiments, keeper 141 may be an o-ring composed of metal, plastic, rubber or combinations thereof. Keeper 141 is received in groove 140 to retain support arm 24 on link engaging stud portion 138. Additionally, cam body 129a includes guide plate portion 142 positioned between link engaging stud portion 138 and aperture engaging portion 137. Guide plate portion 142 is dimensioned so as to be larger than aperture 132, thereby preventing adjustable cam 129 from being drawn therethrough. Further, guide plate portion 142 may serve as a seat for guiding and supporting support arm 24.

Aperture engaging portion 139 generally includes post 143 and cam 144, both of which are substantially concentric with respect to axis B-B. Cam 144 has a pair of opposing lobes 150, each presenting opposing aperture contact surfaces 152. As depicted, aperture contact surfaces 152 may be slightly concave between post 143 and lobe ends 154. Cam 144 and aperture 132 are coordinatingly dimensioned so that cam 144 is rotatably shiftable in aperture 132 about the vertical axis denoted C-C in the figures.

Retainer 129b is received on post 143 so as to retain adjustable cam 129 within aperture 132 on track 122 as before. Again, retainer 129b may be a metal ring interference fit onto post 143 so as to clamp track 22 between retainer 129b and guide plate portion 142. In other embodiments, retainer 129b may be an O-ring, split ring, or the like, made from metal, plastic, rubber or combinations thereof. Retainer 129b and post 143 are received in pocket 35 so that track 22 may be mounted flush to window frame 15.

In some embodiments, post 143 may have a generally cylindrical portion 145 and may be chamfered at end 137 to form a generally frusto-conical end on post 143. Cam portion 144 is disposed between post 143 and arm support portion 142. Cam portion 144 is sized to allow for movement about the vertical axis within aperture 132.

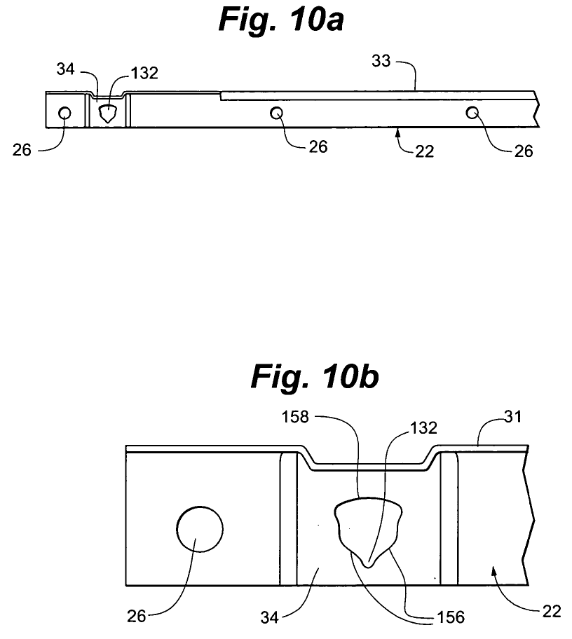

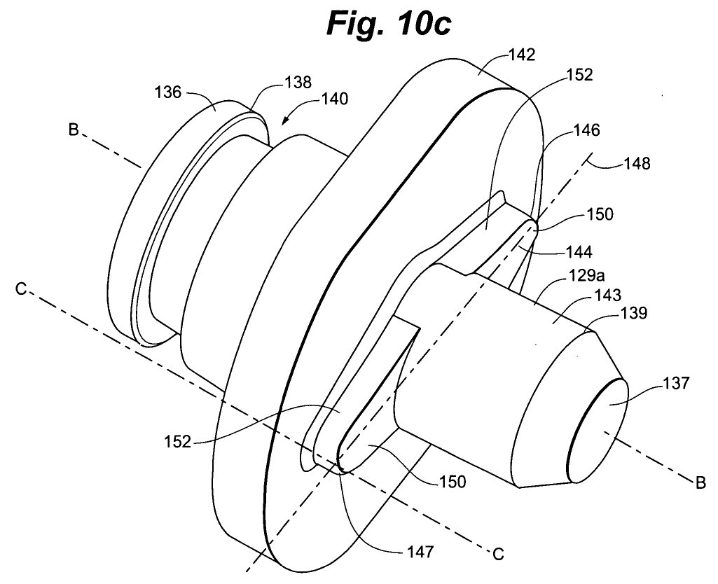

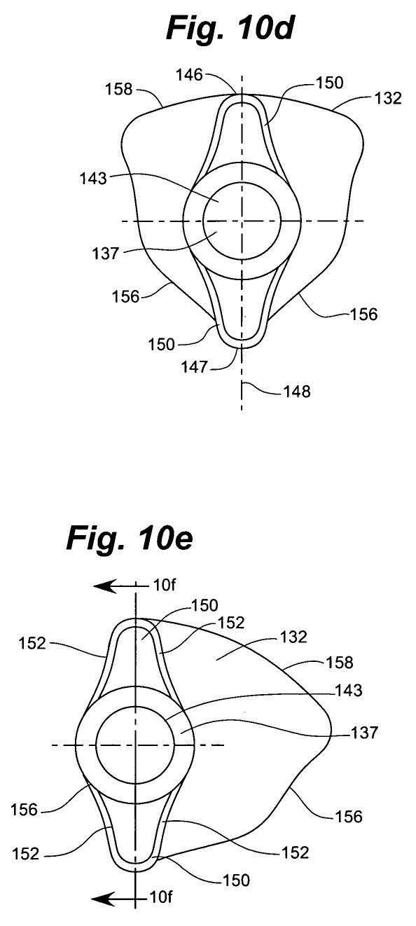

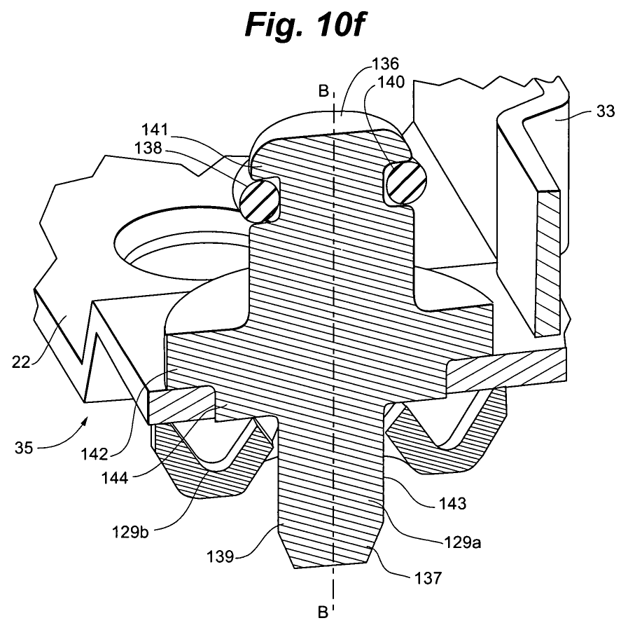

The assembled configuration and operation of adjustable cam 129 is depicted in FIGS. 10d and 10e. “Kernel-shaped” aperture 132 is again a generally tri-lobular opening, but adjacent sides 156 are shaped correspondingly with aperture contact surfaces 152 of cam 144, while third side 158 is generally arcuate. Cam 144 is received in aperture 132, contacting track 22 at endpoints 146, 147 of major axis 148. Cam 144 is rotatably shiftable within aperture 132 about endpoint 147, which coincides with axis C-C. By rotating adjustable cam 129, axis B-B, and post 137 which is concentric therewith, moves relative to the window frame 11 to shift the pivot point at which support arm 24 is pivotably connected with track 22, thereby slightly shifting the position of window sash 15 relative to window frame 11. Adjustable cam 129 is held in the adjusted position solely by the frictional forces between adjustable cam 129 and track 22 resulting from the clamping force applied to track 22 by retainer 129b and guide plate portion 142. Again, there are no discrete structures such as serrations, or protrusions on either adjustable cam 129 or aperture 132 for mechanically locking the device in a position.

Referring to FIG. 10d, cam 144 is centered in aperture 132. From this position, cam 144 can be shifted in either direction about endpoint 147, which facilitates shifting adjustable cam 129 and the attached support arm 24 relative to track 22. Referring to FIG. 10e, adjustable cam 129 and cam 144 are depicted as being shifted to the maximum travel limit within aperture 132. Preferably, cam 144 and aperture 132 are dimensioned so as to enable up to about 35 degrees of rotation in either direction about endpoint 147 when cam 144 is centered in aperture 132 as depicted in FIG. 10d.

The embodiments above are intended to be illustrative and not limiting. One of ordinary skill in the art will recognize that the above description is only one type of hinge assembly, and that the cam and track structures described below can be used with other types of hinges such as, for example, hinges where the sash arm has a fixed pivot axis relative to the track and the support arm is pivotably coupled to a moveable shoe. Although the present invention has been described with reference to particular embodiments, workers skilled in the art will recognize that changes may be made in form and detail without departing from the spirit and scope of the invention.

What is claimed is:

1. A window assembly comprising:
a frame;
a sash; and
at least one hinge operably coupled with the frame and sash to hingably mount the sash in the frame, the hinge comprising:
a track assembly disposed on the frame, the track assembly including an elongate track defining a generally tri-lobular cam engaging structure and a slide portion selectively longitudinally slidable along the track;
a sash arm on the sash, the sash arm having a pair of opposing ends, the sash arm operably coupled to the slide portion proximate one of the ends;
a support arm operably coupling the sash arm and the track; and
an adjustable cam including a link engaging stud portion and a lobular cam portion, the link engaging stud portion operably coupled to the support arm and the cam portion received in the generally tri-lobular cam engaging structure of the track, wherein the cam portion is selectively rotatably shiftable in the cam engaging structure to shift the position of the link engaging stud portion relative to the track.

2. The window assembly of claim 1, wherein the track is generally L-shaped and includes a vertical flange having an overhang portion.

3. The window assembly of claim 1, further comprising a keeper, and wherein the link engaging stud portion defines a groove for receiving the keeper to retain the support arm in contact with the link engaging stud portion of the adjustable cam.

4. The window assembly of claim 1, wherein the adjustable cam further comprises a post adjacent the cam portion.

5. The window assembly of claim 4, further comprising a retainer on the post for frictionally clamping the adjustable cam on the track.

6. The window assembly of claim 5, wherein the retainer is interference fit on the post.

7. The window assembly of claim 4, wherein the post has a cylindrical shape.

8. The window assembly of claim 4, wherein the post has a bullet shape.

9. The window assembly of claim 1, wherein the cam engaging structure is an aperture.

10. The window assembly of claim 9, wherein the cam portion has a pair of opposing lobes, each lobe having a pair of aperture contact surfaces, the aperture contact surfaces correspondingly shaped with a portion of the periphery of the aperture.

11. The window assembly of claim 10, wherein the aperture contact surfaces are concave, and wherein the aperture has a pair of adjacent sides, each of the adjacent sides having an arcuate cutout portion for receiving the cam portion.

12. The window assembly of claim 1, wherein the cam portion is selectively rotatably shiftable within the cam engaging structure up to about thirty-five degrees in either direction from a center position within the cam engaging structure.

13. A method of compensating for sash sag in a casement window including a frame, a sash in frame and a hinge, the hinge including an elongate track on the frame, a sash arm on the sash and a support arm operably coupling the track and the sash arm, the method comprising:
operably coupling the support arm and the track with an adjustable cam member, the adjustable cam member having a lobular cam portion and a support arm engaging stud portion, the track having a generally tri-lobular cam engaging structure, the support arm pivotally coupled to the support arm engaging stud portion and the cam portion selectively rotatable in the cam engaging structure so as to shift the support arm engaging stud portion longitudinally relative to the track; and
rotating the adjustable cam in the cam engaging structure, thereby longitudinally shifting the support arm engaging stud portion.

14. An adjustable hinge assembly comprising:
a track having a generally tri-lobular cam engaging structure;
a slide member longitudinally slidable on the track;
a first elongate arm presenting a pair of opposing ends, the first arm operably coupled to the slide member proximate one of the ends of the first arm;
a second elongate arm presenting first and second opposing ends, the second arm operably coupled to the first arm proximate the first end of the second arm;
a bi-lobular cam member having a cam portion and a link engaging portion, the link engaging portion operably coupled to the second elongate arm proximate the second end, the cam portion engaged in the cam engaging structure and selectively shiftable therein to enable shifting adjustment of the link engaging portion relative to the track.

15. The hinge assembly of claim 14 wherein the cam engaging structure is an aperture in the track.

16. The hinge assembly of claim 15, wherein the cam portion includes a pair of opposing lobes, each lobe having a pair of aperture contact surfaces, the aperture contact surfaces correspondingly shaped with a portion of the periphery of the aperture.

17. The hinge assembly of claim 16, wherein the aperture contact surfaces are concave, and wherein the aperture has a pair of adjacent sides, each of the adjacent sides having an arcuate cutout portion for receiving the cam portion.

18. The hinge assembly of claim 14, wherein the cam member presents a longitudinal axis, the cam member being symmetrical about the longitudinal axis.

19. The hinge assembly of claim 18, wherein the cam portion is concentric with the longitudinal axis of the cam member.

20. The hinge assembly of claim 14, further comprising a retainer operably coupled to the cam member and disposed so as to apply a frictional clamping force on the track.
